(19) United States
(12) Patent Application Publication
(10) Pub. No.: US 2020/0403812 A1
(43) Pub. Date: Dec. 24, 2020

(54) CERTIFICATE ISSUING APPARATUS, VERIFICATION APPARATUS, COMMUNICATION DEVICE, CERTIFICATE ISSUING SYSTEM, CERTIFICATE ISSUING METHOD, AND NON-TRANSITORY COMPUTER READABLE MEDIUM

(71) Applicant: Kabushiki Kaisha Toshiba, Minato-ku (JP)

(72) Inventor: Daisuke Ajitomi, Setagaya (JP)

(73) Assignee: KABUSHIKI KAISHA TOSHIBA, Minato-ku (JP)

(21) Appl. No.: 16/801,259

(22) Filed: Feb. 26, 2020

(30) Foreign Application Priority Data
Jun. 20, 2019 (JP) 2019-114776

(51) Int. Cl. H04L 9/32; H04L 9/14; H04L 9/08; H04L 29/06

(52) U.S. Cl. CPC H04L 9/3268; H04L 9/3247; H04L 63/0876; H04L 9/14; H04L 9/0825; H04L 9/3271

(57) ABSTRACT

An embodiment of the present invention provides a new scheme for issuing a server certificate to a Web server on a private network. A certificate issuing apparatus as one embodiment of the present invention includes a first communicator, a detector, a second communicator, and an electronic signer. The first communicator communicates with a first communication device regarding issuance of a certificate. The detector detects a verification apparatus possessing a second key identical with or corresponding to a first key possessed by the first communication device. The second communicator instructs the detected verification apparatus to verify whether the first communication device is authentic. When the authenticity of the first communication device is proved by the verification which uses the second key, the electronic signer generates the certificate for the first communication device by electronically signing a certificate signing request from the first communication device by using a third key.

### CROSS-REFERENCE TO RELATED APPLICATION(S)

This application is based upon and claims the benefit of priority from Japanese Patent Application No. 2019-114776, filed Jun. 20, 2019; the entire contents of which are incorporated herein by reference.

### FIELD

An embodiment relates to a certificate issuing apparatus, a verification apparatus, a communication device, a certificate issuing system, a certificate issuing method, and non-transitory computer readable medium

### BACKGROUND

The authenticity of a Web server on a public network such as the Internet is guaranteed by a server certificate issued by a public CA (Certificate Authority of Web PKI). However, from a viewpoint of what is called IoT (Internet of Things), Web servers on private networks have been increasing these days, and situations where these Web servers require server certificates have also been increasing.

However, issuing certificates to devices on a private network by a public CA is a great burden to the public CA because of problems of security verification and so on and is not realistic.

### BRIEF DESCRIPTION OF THE DRAWINGS

FIG. 1 is a block diagram illustrating an example of a communication system including a certificate issuing system in one embodiment of the present invention.

FIG. 2 is a communication sequence chart of certificate issuance in the embodiment of the present invention.

FIG. 3 is a schematic flowchart of a series of processes by a certificate issuing server in the embodiment of the present invention.

FIG. 4 is a schematic flowchart of a series of processes by a verification server in the embodiment of the present invention.

FIG. 5 is a block diagram illustrating an example of a hardware configuration in the embodiment of the present invention.

### DETAILED DESCRIPTION

An embodiment of the present invention provides a new scheme for issuing a server certificate to a Web server on a private network.

A certificate issuing apparatus as one embodiment of the present invention includes a first communicator, a detector, a second communicator, and an electronic signer. The first communicator communicates with a first communication device regarding issuance of a certificate. The detector detects a verification apparatus possessing a second key identical with or corresponding to a first key possessed by the first communication device. The second communicator instructs the detected verification apparatus to verify whether the first communication device is authentic. When the authenticity of the first communication device is proved by the verification which uses the second key, the electronic signer generates the certificate for the first communication device by electronically signing a certificate signing request from the first communication device by using a third key.

An embodiment will be explained in detail below with reference to the accompanying drawings. The present invention is not limited to the embodiment.

### One Embodiment of Present Invention

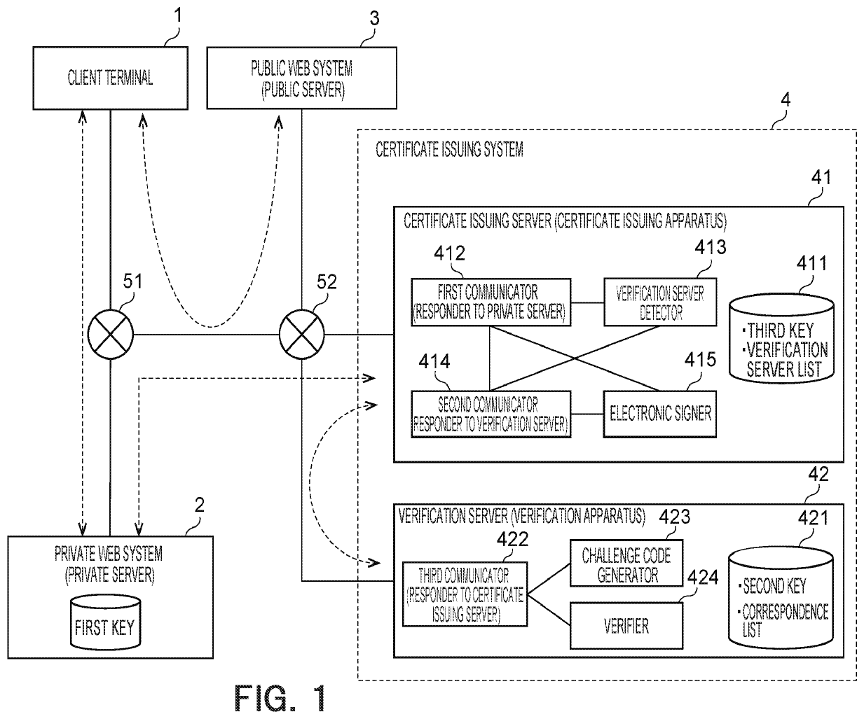

FIG. 1 is a block diagram illustrating an example of a communication system including a certificate issuing system according to one embodiment of the present invention. The communication system includes a client terminal 1, a private Web system 2, a public Web system 3, and a certificate issuing system 4. The certificate issuing system 4 includes a certificate issuing server 41 (certificate issuing apparatus) and a verification server 42 (verification apparatus). The certificate issuing server 41 includes a storage device 411, a first communicator 412 (responder to a private server), a verification server detector 413, a second communicator 414 (responder to the verification server), and an electronic signer 415. The verification server 42 includes a storage device 421, a third communicator 422 (responder to the certificate issuing server), a challenge code generator 423, and a verifier 424.

The certificate issuing system 4 may have a server other than the certificate issuing server 41 and the verification server 42. For example, it may include a front-end server which controls the communication between the certificate issuing system 4 and an external part.

Unlike the certificate issuing system 4, the private Web system 2 and the public Web system 3 each may be constituted by one server or may be constituted by a plurality of servers including the aforesaid front-end server. For convenience' sake, the following description uses an example in which the Web systems 2, 3 are each constituted by one server. The private Web system 2 and the public Web system 3 will be referred to simply as the “private server 2” and the “public server 3” respectively.

A communication network of the communication system is divided into at least a private network 51 and a public network 52. The client terminal 1 and the private server 2 belong to the private network 51. The public server 3 and the certificate issuing system 4 belong to the public network 52. It can be assumed that the private server 2 always communicates with the verification server 42 not directly but through the certificate issuing server 41. Under this assumption, the verification server 42 need not connect directly with the public network 52. A configuration example in this case may be that the verification server 42 connects with a private network provided in the certificate issuing system 4 and communicates with the certificate issuing server 41 through the private network.

The private network 51 is configured with private IP addresses. A home network for household use, an intranet of an organization, and the like are examples of the private network 51. The public network 52 is configured with global IP addresses. The Internet and the like are examples of the public network 52. The public network 52 and the private network 51 communicate with each other through a relay device such as a router which connects the private network 51 and the public network 52. Since the relay device is an ordinary one and is not specialized for this communication system, the illustration and description thereof will be skipped.

In this communication system, the client terminal 1 communicates in parallel with both the private server 2 and the public server 3 which are communication partners belonging to different networks. As the communication, encrypted communication based on mutual authentication is assumed. Possible examples include HTTPS (Hyper Text Transfer Protocol Secure) and TLS (Transport Layer Security).

Possible examples of the client terminal 1 include PC (Personal Computer), a smartphone, and a tablet. It is assumed that the client terminal 1 is implemented with a Web browser which provides access to Web services.

The private server 2 is accessed from the client terminal 1 or from the public server 3 through the client terminal 1. The private server 2 receives an HTTP request from the client terminal 1 and returns an HTTP response. That is, the private server 2 has a function as an HTTP server (Web server).

The private server 2 may be, for example, a household electronic product connected as an IoT device to a home network. Possible examples of the household electronic product include a TV recorder connected to a home network to accept recording reservation on-line. Besides, it may be an electronic device connected to an intranet of an organization. Possible examples of the electronic device include a manufacturing apparatus connected to an intranet of a factory so as to be controlled on-line.

The public server 3 is accessed from the client terminal 1 or from the private server 2 through the client terminal 1. The public server 3 also receives an HTTP request from the client terminal 1 and returns an HTTP response. That is, the public server 3 also has a function as an HTTP server (Web server).

The public server 3 executes a Web service provided on, for example, the Internet. Possible examples of the Web service include a Web service providing, on the Internet, a Web page for controlling a manufacturing apparatus connected to an intranet of a factory. That is, it can be a Web service on the public network 52, that may access the private server 2 belonging to the private network 51.

To use such a Web service, the client terminal 1 accesses the public server 3 by using the Web browser. The Web service provided by the public server 3 is loaded to the Web browser. Then, the Web browser tries to receive data from the private server 2 in response to an instruction from the loaded Web service. That is, the public server 3 accesses the private server 2 through the Web browser on the client terminal 1.

In the above example of the Web service, let us assume a situation where the public server 3 has a server certificate but the private server 2 does not have a server certificate. In this situation, the client terminal 1 and the public server 3 are not able to confirm the authenticity of the private server 2. This may not allow the client terminal 1 to use the Web service. For example, in a case where an origin from which data is obtained is divided into a plurality of origins, that is, where cross-origin communication is necessary, the Web browser which displays Web pages usually rejects the cross-origin communication unless the authenticity of each of the origins can be confirmed from the server certificate. This may cause a trouble of, for example, the non-display of part of the Web service.

To prevent such a trouble, the private server 2 requests and obtains a server certificate from the certificate issuing system 4 before communicating with the client terminal 1. Then, the private server 2 presents the server certificate to the client terminal 1 at the time of the communication. This enables the secure cross-origin communication even if the origin is divided into the private network 51 and the public network 52. Note that “secure” mentioned here means that the private server 2 and the public server 3 are both able to mutually verify the authenticity and are able to perform encrypted communication.

The certificate issuing system 4 will be described. As previously described, the certificate issuing system 4 of this embodiment includes at least the certificate issuing server 41 and the verification server 42.

The certificate issuing server 41 accepts a request for issuing a server certificate from the private server 2, and when the authenticity of the private server 2 is proved, issues the server certificate.

Preferably, the certificate issuing server 41 is managed by a public CA and a certificate issued by the certificate issuing server 41 is electronically signed using a secret key (third key) of the public CA. The secret key of the public CA will be hereinafter referred to as “CA key”. That is, the certificate issuing server 41 is preferably a public CA. The public CA is registered as default in the Web browser of the ordinary client terminal 1. Therefore, a work of approving an issuer of a server certificate is not necessary in the client terminal 1, which can be time and effort-saving for a user of the client terminal 1.

Access from the public network 52 to the private network 51 is usually restricted by the relay device. Therefore, it is difficult for the public CA to verify the private server 2. Further, a home network for household use which is one example of the private network 51 often has no network manager. It is also difficult for the public CA to objectively determine the safety of a communication device in such a home network for household use. On the other hand, the certificate issuing system 4 in this embodiment solves such a problem by using the verification server 42 and issues a server certificate bearing a CA key-based electronic signature, irrespective of whether or not a communication device requesting the server certificate belongs to the public network 52.

The verification server 42 verifies whether the private server 2 is authentic so that the server certificate can be issued to the private server 2. That is, in the certificate issuing system 4 of this embodiment, the certificate issuing server 41 entrusts the verification necessary for the issuance of the server certificate to the verification server 42.

For proving the authenticity of the private server 2, a secret key (first key) possessed by the private server 2 is used. The verification server 42 has a correspondence list showing the correspondence relation between verification-target communication devices and secret keys possessed by the verification-target communication devices. In this case, the verification server 42 need not have the secret keys themselves in the correspondence list, but in a case where public-key cryptography is based on, the verification server 42 only needs to have public keys which are pairs to the secret keys, or public key-based certificates. Further, the verification server 42 also has keys (second keys) for verifying the secret keys possessed by the verification-target communication devices. This key will be hereinafter referred to as “verification key”. The private server 2 transmits, to the certificate issuing system 4, data for identifying the private server 2, such as an identification number unique to the private server 2. This data will be hereinafter referred to as “private server ID. The private server ID may be unique to each device or may be one common to a set of devices, such as a device model number, for instance. The verification server 42 refers to the correspondence list to select a verification key corresponding to the secret key possessed by the private server 2, on the basis of the private server ID. Then, the private server 2 transmits verification-target data to the certificate issuing system 4, and the verification server 42 verifies the verification-target data by using the verification key. For example, when receiving an electronic signature as the verification-target data, the verification server 42 verifies whether or not the electronic signature is based on the secret key of the private server 2. If it turns out that the electronic signature is based on the secret key of the private server 2, the authenticity of the private server 2 is proved.

Let us assume that the private server 2 possesses the secret key and the verification server 42 possesses the correspondence list and the verification keys as described above. The verification key may be PSK (Previous Shared Key) with the private server 2 or may be the public key corresponding to the secret key of the private server 2. That is, the verification server 42 possesses the verification key identical with or corresponding to the key possessed by the private server 2. Further, a method of generating and a method of registering the verification key possessed by the verification server 42 are not limited as long as whether the secret key is possessed by the private server 2 can be confirmed from the verification key.

For example, a manufacturer/vendor of the private server 2 also manages the verification server 42, generates the secret key when manufacturing the private server 2, and registers the secret key in the private server 2. The manufacturer/vendor further causes the verification server 42 to register the private server ID and the secret key in an associated manner in the correspondence list. As a result, the verification server 42 and the private server 2 have the secret key in common. Then, if the private server 2 transmits data that is encrypted with the secret key of the private server 2, the verification server 42 is able to prove the authenticity of the private server 2 by using the secret key identical with the secret key of the private server 2.

There may also be a case where the verification server 42 generates and sends out the secret key when receiving a request from a manufacturer/vendor. For example, before manufacturing the private server 2, the manufacturer/vendor of the private server 2 transmits the private server ID to request the verification server 42 to generate the secret key. The verification server 42 generates the secret key and transmits it to the manufacturer/vendor while registering the private server ID and the secret key in an associated manner. The manufacturer/vendor registers the secret key obtained from the verification server 42 in the private server 2 when manufacturing the private server 2. In this case as well, the verification server 42 is able to prove the authenticity of the private server 2 by using the secret key identical with the secret key of the verification server 42.

Another example is that TMP (Trusted Platform Module) of the private server 2 generates a key pair of the public key and the secret key and transmits the public key in the pair to the verification server 42 together with the private server ID. The verification server 42 records the public key and the private server ID in an associated manner. In this case as well, the verification server 42 is able to prove the authenticity of the private server 2 by using the public key corresponding to the secret key of the verification server 42.

The secret key of the private server 2 may be unique to the private server 2 or may be unique to each specific kind, for example, each product model number. In the case where the secret key is unique to each specific kind, the private server ID may also be data indicating the specific kind.

It is possible to generate a new secret key on the basis of the secret key and by using the original secret key or the public key corresponding to the original secret key, it is possible to confirm whether or not verification-target data is generated on the basis of the new secret key. That is, the verification-target data may be data regarding the new secret key which is generated on the basis of the secret key of the private server 2.

It can be assumed that the certificate issuing system 4 includes a plurality of verification servers 42. Under such assumption, the certificate issuing server 41 registers data for identifying the verification servers 42 in a verification server list to manage them. The data will be referred to as “verification server ID”. Under such assumption, the private server 2 may designate a verification server 42 by notifying the verification server ID to the certificate issuing server 41.

It can also be assumed that the certificate issuing server 41 specifies a manufacturer/vendor from an identification number or the like of a device and entrusts the verification to a verification server 42 managed by the specified manufacturer/vendor. Under such assumption, the verification server 42 can be indirectly specified from the identification number of the device. The device identification number or the like thus enabling the indirect specification of the verification server 42 is also the verification server ID.

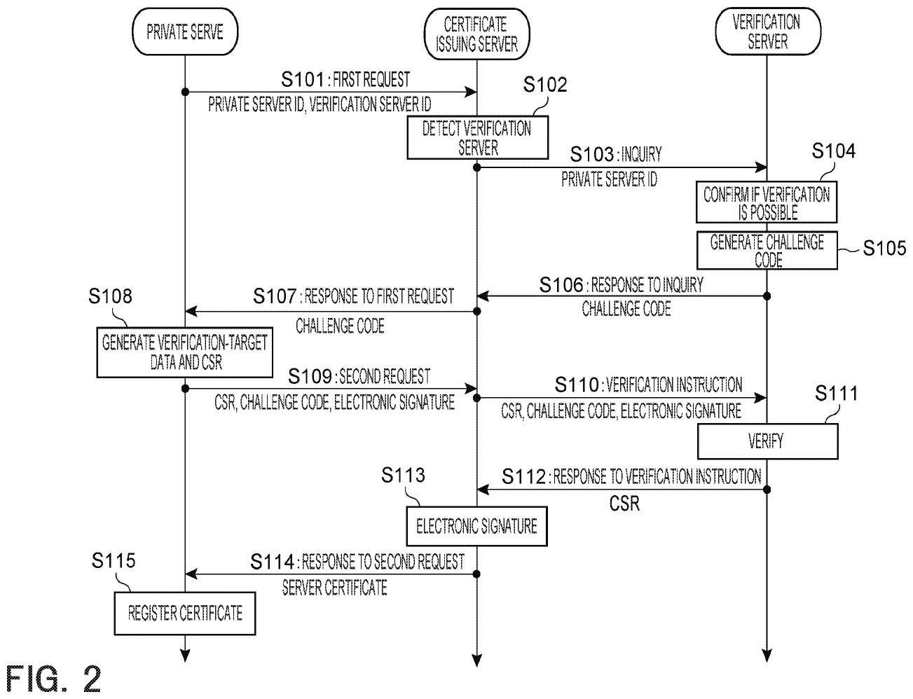

The flow of the certificate issuance by the certificate issuing system 4 will be described. FIG. 2 is a communication sequence chart of the certificate issuance in the embodiment of the present invention. This chart illustrates the flow in which no error occurs in the issuance of a server certificate.

The private server 2 requests the certificate issuing system 4 to issue a server certificate (S101). In this description, this first communication is referred to as “first request”. In the example in FIG. 2, the private server ID and a verification server ID are transmitted in the first request.

The certificate issuing server 41 detects a verification server 42 by using the verification server ID (S102). Then, the certificate issuing server 41 transmits the private server ID to the detected verification server 42 to make an inquiry (S103). The verification server 42 confirms whether or not it is able to verify the private server 2 corresponding to the received private server ID, that is, whether or not the verification server 42 possesses a verification key corresponding to this private server 2 (S104).

When confirming that it is capable of the verification, the verification server 42 generates a challenge code for use in the confirmation of the authenticity of the private server 2 (S105) and transmits the challenge code to the certificate issuing server 41 as a response to the inquiry (S106). The certificate issuing server 41 transfers the challenge code to the private server 2 as a response to the first request (S107). Note that the challenge code may be transmitted from the verification server 42 to the private server 2 not though the certificate issuing server 41.

The challenge code is transmitted as a response to a communication device that is a requester of the first request and is transmitted when the communication device makes a later-described second request. This makes it possible to prove that the communication device which is the requester of the first request and the communication device which is the requester of the second request are the same, to prevent spoofing. It can be assumed that the challenge code is a random number character string. The challenge code may be NONCE (Number used ONCE) whose use is permitted only once.

The private server 2 which has received the challenge code generates verification-target data and CSR (Certificate Signing Request) (S108) and transmits these to the certificate issuing server 41 together with the challenge code (S109). In this description, the transmission of the verification-target data is referred to as “second request”. That is, in the second request, the verification-target data, CSR, and the challenge code are transmitted. In the example in FIG. 2, an electronic signature based on the secret key of the private server 2 is transmitted, as the verification-target data.

CSR is a file containing information regarding the private server 2 and is a file from which the server certificate is generated. This CSR is made into the server certificate by being electronically signed.

Since CSR can contain the information regarding the private server 2, the private server 2 may generate CSR including the challenge code and the verification-target data to transmit it to the certificate issuing server 41. In this case, though only CSR appears to be transmitted in the second request, the certificate issuing system 4 is able to obtain the verification-target data, CSR, and the challenge code.

The private server 2 may perform the electronic signing based on the secret key of the private server 2 to the challenge code. That is, the challenge code may be encrypted on the basis of the secret key of the private server 2. In this case, though it appears that CSR and the electronic signature which is the verification-target data are transmitted in the second request, the certificate issuing system 4 is able to obtain the verification-target data, CSR, and the challenge code. The electronic signature to the challenge code may be included in CSR.

The certificate issuing server 41 transfers the second request to the verification server 42 and instructs the verification server 42 to perform the verification (S110). The verification server 42 verifies the verification-target data included in the second request by using the verification key (S111). Note that, from the challenge code, the verification server 42 is able to verify that the requester of the second request is the requester of the first request. Therefore, the private server 2 may transmit the second request to the verification server 42 not through the certificate issuing server 41.

The verification server 42 notifies the certificate issuing server 41 that the authenticity of the private server 2 has been confirmed (S112), and the certificate issuing server 41 generates the server certificate by electronically signing CSR by using the CA key possessed by the certificate issuing server 41 (S113). In this manner, when the authenticity of the private server 2 is proved by the verification using the verification key, the CA key-based server certificate is generated. Note that the verification server 42 may also electronically sign CSR. Instead, the certificate issuing server 41 may add data indicating the verification server 42 to CSR.

The generated server certificate is transmitted to the private server 2 as a response to the second request (S114). That is, the server certificate is issued to the private server 2. The private server 2 registers the issued server certificate (S115). Consequently, the private server 2 is able to present the CA key-based server certificate in the communication with the client terminal 1 and with the public server 3. For example, this enables the Web browser to recognize that both origins, namely, the private server 2 and the public server 3 are reliable to allow the cross-origin communication by the client terminal 1 with the private server 2 and the public server 3. Further, for example, it is possible to use ID and a password of a Web service of the public server 3 commonly in a Web service of the private server 2. That is, single sign-on allowing log-in to a plurality of Web services with ID and a password of one Web service is achieved.

Processing by the certificate issuing server 41 will be described in detail with its constituent elements. The storage device 411 of the certificate issuing server 41 stores at least keys used in the issuance of server certificates and the verification server list used in the detection of a verification server 42. Verification server-related data necessary for the processing by the certificate issuing server 41, such as address data of the verification servers 42 is also stored in the verification server list.

The first communicator 412 communicates with the private server 2 regarding the issuance of a server certificate. For example, the first communicator 412 accepts a first request and transmits, to the private server 2, a challenge code received from the verification server 42, as a response to the first request.

Further, when receiving a request from the private server 2, the first communicator 412 confirms if the request includes necessary data. The data will be hereinafter referred to as evidence. If the request includes the evidence and is acceptable, the first communicator 412 instructs a constituent element that performs the next processing to perform the processing. If the request is unacceptable because, for example, the request does not include the evidence, the first communicator 412 sends an error response to the private server 2.

The error response preferably includes a reason why the request is unacceptable. For example, if the challenge code is not included in a second request, the first communicator 412 includes, in the error response to the second request, the notification that the challenge code is not included. In this manner, the first communicator 412 may generate the error response to notify the private server 2 of the evidence which is not included. Note that the evidence in the first request and that in the second request are different.

If part of the necessary evidence is included, after the processing using the included evidence is performed, the processing result and a request for the transmission of non-included evidence may both be sent as a response. For example, if the first request does not include the private server ID but includes a verification server ID, a verification server 42 can be specified and therefore, the verification server 42 may be requested to generate the challenge code, and the challenge code and the error may both be included in the response to the private server 2.

If the evidence is not included but the verification server 42 that is to perform the verification can be detected from data other than the evidence, the first communicator 412 may include the address data of the detected verification server 42 in the error response and transmit the error response to the private server 2 to prompt the private server 2 to communicate directly with the detected verification server 42.

The verification server detector 413 detects a verification server 42 that possesses a verification key identical with or corresponding to the key possessed by the private server 2. For example, a verification server 42 may be designated by the private server 2. Instead, an identification number of a device is transmitted as a verification server ID, and on the basis of the identification number of the device, the verification server detector 413 detects a verification server 42 that possesses a secret key identical with or a public key corresponding to a secret key possessed by the device having this identification number. For example, the verification server list may include a table showing the relation between device identification numbers and manufacturers/vendors and a table showing the relation between the manufacturers/vendors and the verification servers 42, and the verification server detector 413 may detect a verification server 42 on the basis of these tables. Instead, an inquiry may be made to a Web service that finds a manufacturer/vendor from the device identification number.

Further, the verification server detector 413 may determine whether or not the verification server 42 corresponding to the obtained verification server ID is permitted to be used, to detect the verification server 42 on the basis of the determination. For example, trusted verification servers 42 are registered as a white list in the verification server list in advance. Then, if it is found that there are a plurality of verification servers 42 corresponding to the verification server ID, the verification servers 42 included in the white list are prioritized in deciding the verification server 42 for use in the verification this time. Further, if the verification server 42 is designated by the verification server ID from the private server 2 but the designated verification server 42 is not included in the white list, it may be decided that there is no usable verification server 42. If it is decided that there is no usable verification server 42, the first communicator 412 may notify the private server 2 that the designated verification server 42 is not usable by transmitting an error response to the private server 2.

The second communicator 414 gives an instruction to the verification server 42 and accepts a response to the instruction. Specifically, if the verification server 42 is detected by the verification server detector 413, the second communicator 414 instructs the detected verification server 42 to generate a challenge code. Further, when a second request is received from the private server 2, the second communicator 414 instructs the detected verification server 42 to verify whether the private server 2 is authentic. Note that the second communicator 414 may transmit all the data regarding the second request to the verification server 42 or may transmit only verification-target data to the verification server 42. For example, in the case where the verification server 42 electronically signs CSR, CSR is transmitted to the verification server 42, but in the case where the verification server 42 does not electronically sign CSR, CSR need not be transmitted to the verification server 42.

When the verification server 42 proves the authenticity of the private server 2, the second communicator 414 instructs the electronic signer 415 to generate a server certificate.

When the authenticity of the private server 2 is proved by the verification which uses the verification key, the electronic signer 415 electronically signs CSR from the private server 2 by using the secret key possessed by the certificate issuing server 41 to generate the server certificate. In the case where the verification server 42 does not append an electronic signature to CSR, the electronic signer 415 may electronically sign CSR after appending, to CSR, data for identifying the verification server 42 entrusted with the verification. When the verification server 42 appends the electronic signature to CSR, the electronic signing is further performed using the secret key possessed by the certificate issuing server 41. Therefore, two electronic signatures, namely, the electronic signature of the certificate issuing server 41 and the electronic signature of the verification server 42 are appended to the server certificate.

For the electronic signing, the CA key used for a server certificate that is to be issued to a communication device belonging to the public network 52 is especially preferably used. In this embodiment, it is not determined whether a communication device requesting the issuance of a certificate belongs to the private network 51 or the public network 52. Therefore, the CA key-based server certificate is issued irrespective of whether or not the communication device requesting the issuance of the certificate belongs to the public network 52.

After the authenticity of the private server 2 is confirmed, verification processing of confirming the presence of a domain may be performed. Specifically, the certificate may be issued after not only the processing of confirming the authenticity of the private server 2 but also the processing of confirming whether or not the domain is actually present and whether or not an entity requesting the issuance of the certificate is capable of managing and controlling the domain is performed by, for example, the method described in Japanese Patent Laid-Open Publication No. 2019-087889 which is premised on ACME protocol.

The processing by the verification server 42 will be described in detail together with its constituent elements. The storage device 421 of the verification server 42 stores at least the correspondence list and the verification keys. It also stores keys for use in the electronic signing in the case where the verification server 42 electronically signs CSR.

The third communicator 422 communicates with the certificate issuing server 41 regarding the verification of whether the private server 2 is authentic. For example, the third communicator 422 accepts a verification instruction from the certificate issuing server 41 and transmits the verification result to the certificate issuing server 41 as a response to the verification instruction.

Further, the third communicator 422 receives an instruction from the certificate issuing server 41 and confirms whether or not it is capable of handling the instruction. For example, when receiving an inquiry regarding the private server 2, the third communicator 422 confirms whether or not the verification server 42 possesses a verification key corresponding to the secret key corresponding to the received private server ID. If the verification key is possessed and the instruction is acceptable, the third communicator 422 instructs a constituent element that performs the next processing to perform the processing. If the request is unacceptable because, for example, the verification key is not possessed or an evidence such as a challenge code is not included, an error response is transmitted to the certificate issuing server 41. The error response preferably includes a reason why the request is unacceptable.

Further, when accepting the verification instruction regarding the private server 2, the third communicator 422 instructs the verifier 424 to perform the verification.

The challenge code generator 423 generates a challenge code. A method of generating the challenge code is not limited, and may be a known method. When the challenge code is generated, the third communicator 422 transmits the challenge code to the private server 2.

The verifier 424 verifies verification-target data transmitted from the private server 2, by using the verification key of the verification server 42 to verify whether the private server 2 is authentic. A verification method may be a known method. Further, the verifier 424 also checks whether data transmitted from the private server 2 includes the challenge code generated by the verification server 42.

How the processing performed in the certificate issuing system 4 is shared by the certificate issuing server 41 and the verification server 42 is not limited to the example of this embodiment and can be changed as needed. Therefore, the certificate issuing server 41 and the verification server 42 each may include a constituent element of the other server as needed. For example, the certificate issuing server 41 may further include the challenge code generator 423, and a challenge code by the certificate issuing server 41 and a challenge code by the verification server 42 may be generated to be both used in the communication with the private server 2. Another example may be that the verification server 42 also includes the electronic signer 415, and the electronic signature by the verification server 42 may be appended to CSR.

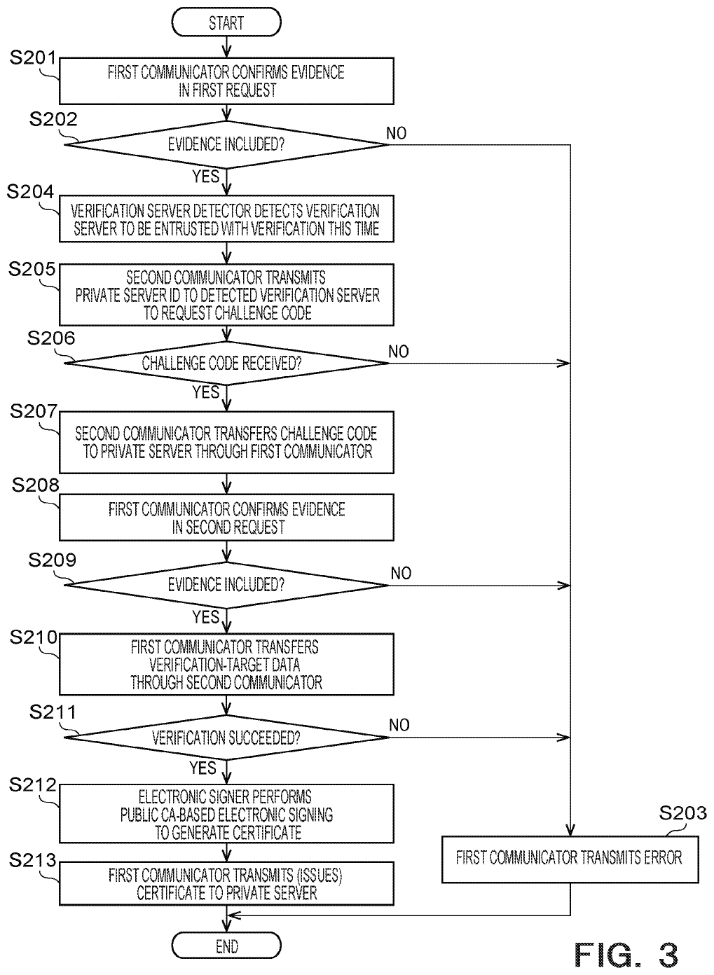

Next, the flow of the processing of each constituent element will be described. FIG. 3 is a schematic flowchart of a series of processes by the certificate issuing server 41 in the embodiment of the present invention. This flow starts when the first communicator 412 receives a first request from the private server 2.

The first communicator 412 confirms if the first request includes an evidence (S201). If the evidence is not included (NO at S202), the first communicator 412 transmits an error to the private server 2 (S203) and this flow ends. If the private server 2 retransmits the first request in response to the error, this flow starts again.

If the evidence is included (YES at S202), the verification server detector 413 detects a verification server 42 that is to be entrusted with the verification this time, on the basis of a verification server ID (S204). The second communicator 414 transmits the private server ID to the detected verification server 42 to request a challenge code (S205).

If the challenge code is not thereafter received from the verification server 42 (NO at S206), it is determined that the verification is not possible and the first communicator 412 transmits an error to the private server 2 (S203). If receiving the challenge code from the verification server 42 (YES at S206), the second communicator 414 transfers the challenge code to the private server 2 through the first communicator 412 (S207).

Thereafter, the first communicator 412 receives a second request and confirms if the second request includes an evidence (S208). If the evidence is not included (NO at S209), the first communicator 412 transmits an error to the private server 2 (S203). If the evidence is included (YES at S209), the first communicator 412 transfers at least verification-target data to the verification server 42 through the second communicator 414 (S210).

If the second communicator 414 does not thereafter receive a notification of a success in the verification from the verification server 42 (NO at S211), it is determined that a server certificate is not issuable and the first communicator 412 transmits an error to the private server 2 (S203). If the second communicator 414 receives the notification of a success in the verification from the verification server 42 (YES at S211), the electronic signer 415 performs the public CA-based electronic signing to generate the server certificate (S212). Then, the first communicator 412 transmits the certificate to the private server 2 (S213). In this manner, the server certificate is issued and is registered in the private server 2.

It should be noted that the above flowchart is an example and the flow can be a different flow. For example, if the error is transmitted to the private server 2 in the branch from S209 (S203), the retransmission of the second request may be accepted. In this case, the flow does not start at S201 but starts at the processing of S208. The flow thereafter is also the same.

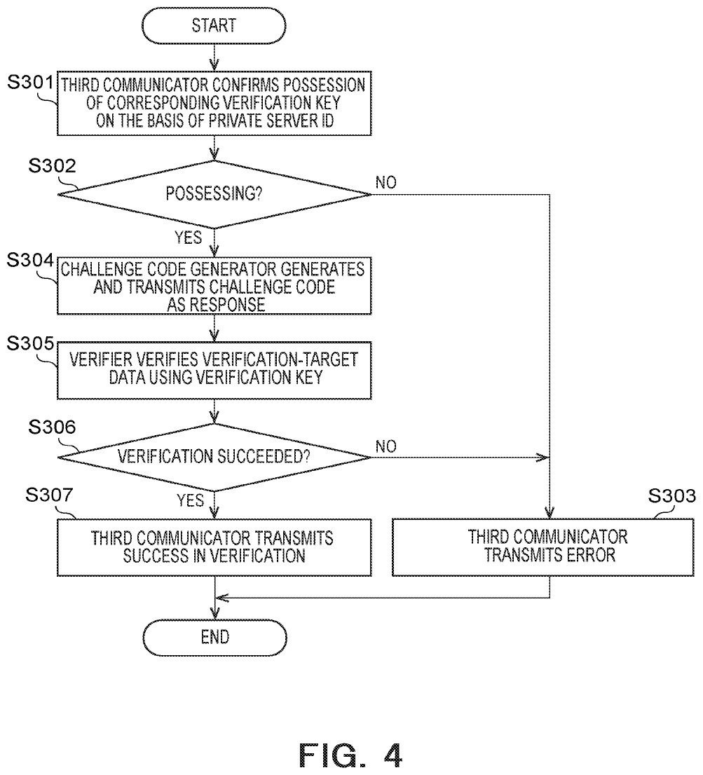

FIG. 4 is a schematic flowchart of a series of processes by the verification server 42 in the embodiment of the present invention. This flow starts when the third communicator 422 receives the private server ID from the certificate issuing server 41.

On the basis of the private server ID, the third communicator 422 confirms if a corresponding verification key is possessed (S301). If the possession is not confirmed (NO at S302), the third communicator 422 transmits an error (S303). If the possession is confirmed (YES at S302), the challenge code generator 423 generates a challenge code and transmits it as a response through the third communicator 422 (S304).

When the third communicator 422 thereafter receives verification-target data, the verifier 424 verifies the verification-target data by using the verification key whose possession is confirmed previously (S305). If the verification does not succeed (NO at S306), the third communicator 422 transmits an error (S303). If the verification succeeds (YES at S306), the third communicator 422 transmits a success in the verification (S307). In this manner, the certificate issuing server 41 is notified of the success in the verification and issues a server certificate.

As described above, the embodiment of the present invention provides the certificate issuing system 4 which is a new scheme for issuing a server certificate. The certificate issuing system 4 is capable of automatically issuing the server certificate to a Web server belonging to the private network 51.

Further, since the verification is entrusted to the verification server 42, the load to the certificate issuing server 41 is distributed. This makes it possible to issue server certificates even to an enormous number of IoT devices.

Further, a public CA-based electronic signature can be appended to a server certificate. Owing to the public CA-based server certificate possessed by a communication device belonging to the private network 51, the secure cross-origin communication is enabled even if the origin is divided into the private network 51 and the public network 52.

There may be a case where a communication device belonging to the private network 51 obtains a server certificate from a private CA that can be privately built. However, a Web browser does not usually accept a server certificate issued by a private CA. Therefore, the Web browser needs to be modified so as to approve the server certificate issued by the private CA with the permission of a user. For example, in the client terminal 1, a work of registering a route certificate for approving the private CA which is an issuer of the server certificate is necessary. Further, even if the setting is made in the client terminal 1, the public server 3 is not able recognize the authenticity of the private server 2. This involves a risk of communicating with a different Web server that is made to pretend to be the private server 2 by a malicious user.

On the other hand, since the public CA is registered as default in the Web browser, the registration work by a user is not necessary. Further, from the server certificate certified by the public CA, the public server 3 is also able to recognize the authenticity of the private server 2. Therefore, in this embodiment, it is possible to prevent the problems of the poor security and trouble taken for the work which are involved in the use of a private CA.

Further, the Web browser usually has a function of displaying an electronic signature appended to a server certificate. This function enables the user of the client terminal 1 to visually check the electronic signature appended to the server certificate of the private server 2 and confirm security by himself/herself. In the case where the electronic signature by the verification server 42 is appended, it is possible to recognize not only the public CA but also the verification server 42 to further confirm security.

Note that the client terminal 1, the private server 2, the public server 3, the certificate issuing server 41, and the verification server 42 which are the constituent elements of the communication system of this embodiment are named according to their use, but they can be said as communication devices because they are capable of wired or wireless communication.

Note that at least part of the above-described embodiment may be implemented by a specialized electronic circuit (that is, hardware) such as IC (Integrated Circuit) implemented with a processor, a memory, and so on. Further, at least part of the above-described embodiment may be implemented through the execution of software (program). It is possible to implement the processing of the above-described embodiment by, for example, using a general-purpose computer device as basic hardware and causing a processor such as CPU mounted in the computer device to execute the program.

For example, a computer can be the client terminal 1, the private server 2, the public server 3, the certificate issuing server 41, or the verification server 42 of the above-described embodiment by reading specialized software stored in a computer-readable storage medium. The kind of the storage medium is not limited. Besides, a computer can be the device of the above-described embodiment by installing therein specialized software downloaded through a communication network. In this manner, data processing by the software is concretely implemented using a hardware resource.

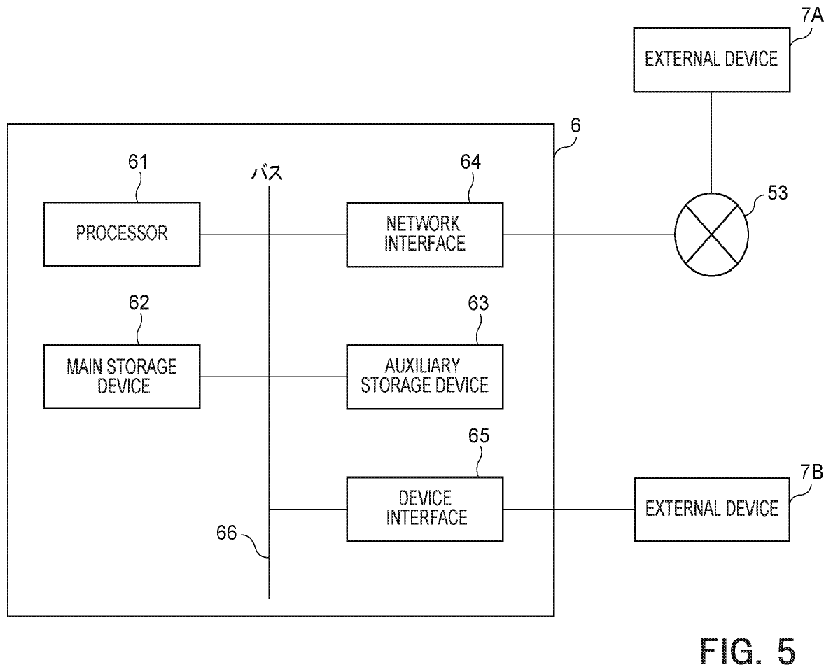

FIG. 5 is a block diagram illustrating an example of a hardware configuration in the embodiment of the present invention. The client terminal 1, the private server 2, the public server 3, the certificate issuing server 41, and the verification server 42 can each be implemented as a computer device 6 including a processor 61, a main storage device 62, an auxiliary storage device 63, a network interface 64, and a device interface 65 which are connected through a bus 66. The storage devices 411 and 421 can each be implemented by the main storage device 62 or the auxiliary storage device 63, and the constituent elements except the storage devices 411 and 421 can be implemented by the processor 61.

It should be noted that the computer device 6 may include a plurality of the same constituent elements though the number of each of the constituent elements included in the computer device 6 in FIG. 5 is one. Further, the single computer device 6 is illustrated in FIG. 5, but software may be installed in a plurality of computer devices and the plurality of computer devices may execute different parts of the processing of the software.

The processor 61 is an electronic circuit including a computer control unit and an arithmetic unit. The processor 61 performs the arithmetic processing on the basis of data and programs input from the devices and so on of the internal configuration of the computer device 6 and outputs the arithmetic results and control signals to the devices and so on. Specifically, the processor 61 executes OS (Operating System) of the computer device 6, application, and so on to control the devices included in the computer device 6. The processor 61 is not limited, provided that it is capable of executing the above-described processing.

The main storage device 62 is a storage device storing instructions which are to be executed by the processor 61, various kinds of data, and so on. The processor 61 directly reads the data stored in the main storage device 62. The auxiliary storage device 63 is a storage device other than the main storage device 62. Note that these storage devices mean any electronic components capable of storing electronic data and may be memories or storages. That is, The storage devices 411 and 421 may be memories or storages. Further, a memory includes a volatile memory and a nonvolatile memory, and the memories may be either of these.

The network interface 64 is an interface for wireless or wired connection with a communication network 53. The network interface 64 may be one conforming to an existing communication protocol. The network interface 64 may exchange data with an external device 7A whose communication is connected through the communication network 53.

The device interface 65 is an interface such as USB which directly connects with an external device 7B. The external device 7B may be an external storage medium or may be a storage device such as database.

The external device 7 may be an output device. For example, the output device may be a display device for displaying images or may be a device which outputs sound or the like. Examples of the output device include LCD (Liquid Crystal Display), CRT (Cathode Ray Tube), PDP (Plasma Display Panel), and a speaker but the output device is not limited to these.

The external device 7 may be an input device. The input device is provided with devices such as a keyboard, a mouse, and a touch panel and gives data input through these devices to the computer device 6. A signal from the input device is output to the processor 61.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A certificate issuing apparatus comprising:
a first communicator configured to communicate with a first communication device regarding issuance of a certificate;
a detector configured to detect a verification apparatus possessing a second key identical with or corresponding to a first key possessed by the first communication device;
a second communicator configured to instruct the detected verification apparatus to verify whether the first communication device is authentic; and
an electronic signer configured to, when the authenticity of the first communication device is proved by the verification which uses the second key, generate the certificate for the first communication device by electronically signing a certificate signing request from the first communication device by using a third key.

2. The certificate issuing apparatus according to claim 1,
wherein the third key used by the electronic signer is a key used for a certificate that is to be issued to a second communication device belonging to a public network.

3. The certificate issuing apparatus according to claim 1,
wherein, when accepting a request for the issuance of the certificate from the first communication device, the first communicator transmits, to the first communication device, a challenge code for use in confirmation of the authenticity of the first communication device, and
wherein, when communication from the first communication device after the transmission of the challenge code does not include the challenge code, the first communicator notifies the first communication device that the challenge code is not included.

4. The certificate issuing apparatus according to claim 1,
wherein, when a verification apparatus is designated by the first communication device but the designated verification apparatus is not included in a predetermined trusted list, the first communicator notifies the first communication device that the designated verification apparatus is not usable.

5. The certificate issuing apparatus according to claim 1,
wherein, when a certificate signing request bearing an electronic signature by the verification apparatus is transmitted from the verification apparatus as a response to the verification instruction, the electronic signer issues the certificate for the first communication device by further electronically signing the certificate signing request bearing the electronic signature by the verification apparatus, by using the third key.

6. The certificate issuing apparatus according to claim 1,
wherein the electronic signer issues the certificate after appending data for identifying the verification apparatus to the certificate signing request at the time of the electronic signing which uses the third key.

7. A verification apparatus comprising:
a third communicator configured to communicate with a certificate issuing apparatus which issues a certificate to a first communication device, regarding verification of whether the first communication device is authentic; and
a verifier configured to verify whether the first communication device is authentic by verifying data from the first communication device by using a second key identical with or corresponding to a first key possessed by the first communication device.

8. The verification apparatus according to claim 7, further comprising
a challenge code generator configured to generate a challenge code for use in confirmation of the authenticity of the first communication device,
wherein the third communicator transmits the challenge code to the first communication device, and
wherein, when verifying whether the first communication device is authentic, the verifier checks whether the data transmitted from the first communication device includes the challenge code, and
wherein, when the challenge code is not included, the third communicator notifies the first communication device that the challenge code is not included.

9. A communication device corresponding to the first communication device recited in claim 3,
wherein the communication device being configured to transmit, to the certificate issuing apparatus when receiving the challenge code, a certificate signing request including at least the challenge code and an electronic signature based on the first key, or a certificate signing request including at least the electronic signature to the challenge code which electronic signature is based on the first key.

10. A communication device corresponding to the first communication device recited in claim 3,
wherein the communication device transmits, to the certificate issuing apparatus when receiving the challenge code, the challenge code or an electronic signature to the challenge code which electronic signature is based on the first key, together with the certificate signing request.

11. A certificate issuing system comprising a certificate issuing apparatus and a verification apparatus,
the certificate issuing apparatus comprising:
a first communicator configured to communicate with a first communication device regarding issuance of a certificate;
a detector configured to detect a verification apparatus possessing a second key identical with or corresponding to a first key possessed by the first communication device;
a second communicator configured to instruct the detected verification apparatus to verify whether the first communication device is authentic; and
an electronic signer configured to, when the authenticity of the first communication device is proved by the verification which uses the second key, generate the certificate for the first communication device by electronically signing a certificate signing request from the first communication device by using a third key, and
the verification apparatus comprising:
a third communicator configured to communicate with the certificate issuing apparatus regarding the verification of whether the first communication device is authentic; and
a verifier configured to verify whether the first communication device is authentic by verifying data from the first communication device by using the second key.

12. A certificate issuing method comprising:
detecting a verification apparatus possessing a second key identical with or corresponding to a first key possessed by a first communication device;
instructing the detected verification apparatus to verify whether the first communication device is authentic; and
when the authenticity of the first communication device is proved by the verification which uses the second key, generating a certificate for the first communication device by electronically signing a certificate signing request from the first communication device by using a third key.

13. A non-transitory computer readable medium in which a program executed by a computer is stored, the program comprising:
detecting a verification apparatus possessing a second key identical with or corresponding to a first key possessed by a first communication device;
instructing the detected verification apparatus to verify whether the first communication device is authentic; and
when the authenticity of the first communication device is proved by the verification which uses the second key, generating a certificate for the first communication device by electronically signing a certificate signing request from the first communication device by using a third key.
